(19) United States
(12) Patent Application Publication
(10) Pub. No.: US 2010/0318727 A1
(43) Pub. Date: Dec. 16, 2010

(54) MEMORY SYSTEM AND RELATED METHOD OF LOADING CODE

(75) Inventors: Sung Hyun LEE, Hwaseong-si (KR); Dongsoo KANG, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/780,977

(22) Filed: May 17, 2010

(30) Foreign Application Priority Data
Jun. 12, 2009 (KR) 10-2009-0052400

(51) Int. Cl. G06F 12/00; G06F 12/16

(52) U.S. Cl. 711/103; 711/104; 711/162; 711/E12.001; 711/E12.008; 711/E12.103

(57) ABSTRACT

A memory system comprises a processor, a main memory comprising a volatile random access memory (RAM) that stores data to be accessed by the processor and a nonvolatile memory that provides a swap space for the RAM, and a disk that provides data transfer to the RAM with a greater latency than the nonvolatile memory.

### CROSS-REFERENCE TO RELATED APPLICATIONS

This application claims priority under 35 U.S.C. §119 to Korean Patent Application No. 10-2009-0052400 filed on Jun. 12, 2009, the disclosure of which is hereby incorporated by reference in its entirety.

### BACKGROUND

Embodiments of the inventive concept relate generally to memory systems. More particularly, embodiments of the inventive concept relate to memory systems and related methods for loading code data.

Memory systems are commonly organized in hierarchies providing varying levels of performance and storage capacity. For instance, many computers use hard disk drives to provide mass data storage, but use other faster forms of memory to store code executed by a processor.

The memories in these hierarchies come in a variety of different forms, including different types of volatile and nonvolatile memories. Volatile memories lose stored data when disconnected from power and examples of volatile memories include dynamic random access memory (DRAM) and static random access memory (SRAM). Nonvolatile memories retain stored data when disconnected from power and examples of nonvolatile memories include electrical erasable programmable read only memory (EEPROM), ferroelectric random access memory (FRAM), phase-change random access memory (PRAM), magnetoresistive random access memory (MRAM) and flash memory.

Flash memory is a particularly common form of nonvolatile due to its relatively efficient performance, low power consumption, and high storage capacity. Due to these and other characteristics, flash memory has been incorporated in a wide variety of memory devices, such as solid state disks (SSDs), memory cards, digital cameras, MP3 players, mobile phones, and personal digital Assistants (PDA), to name but a few.

### SUMMARY

Embodiments of the inventive concept provide memory systems and related methods of operation. Certain embodiments provide methods that can be used to manage data in a hierarchical memory structure. Certain embodiments can decrease the latency of memory access operations.

A method of operating a memory system comprises a processor, a main memory comprising a volatile RAM and a nonvolatile memory, and a disk. The method comprises maintaining separate copies of a page of data in the RAM, the nonvolatile memory, and the disk, transferring the page of data from the nonvolatile memory to the RAM with a first latency, and transferring the page of data from the disk to the RAM with a second latency greater than the first latency.

In certain embodiments, the method further comprises transferring an updated copy of the page of data from the RAM to the nonvolatile memory upon detecting a change in the page of data stored in the RAM.

In certain embodiments, the method further comprises removing the copy of the page of data from the RAM upon determining that the copy of the page stored in the RAM has not been accessed by the processor during a predetermined time interval.

In certain embodiments, the method further comprises removing the copy of the page of data from the nonvolatile upon determining that the copy of the page stored in the nonvolatile memory has not been accessed during a predetermined time interval.

In certain embodiments, the method further comprises transferring an updated copy of the page of data from the nonvolatile memory to the disk upon detecting a change in the page of data stored in the nonvolatile memory.

According to another embodiment of the inventive concept, a memory system comprises a processor, a main memory comprising a volatile RAM that stores data to be accessed by the processor, and a nonvolatile memory that provides a swap space for the RAM, and a disk that provides data transfer to the RAM with a greater latency than the nonvolatile memory.

In certain embodiments, the disk provides an additional swap space for the RAM. In certain embodiments, a page that is not accessed by the processor during a predetermined time interval is stored in the nonvolatile memory during a reclamation operation of the RAM. In certain embodiments, a boot code or data of the memory system is loaded into the RAM during initialization. In certain embodiments, a dirty page stored in the nonvolatile memory is updated in the disk. In certain embodiments, the method further comprises a north bridge connected between the processor and the main memory to transfer data between the processor and the main memory, and a south bridge connected between the north bridge and the disk to transfer data between the processor and the disk. In certain embodiments, the nonvolatile memory is a phase-change random access memory. In certain embodiments, code data stored in the nonvolatile memory is loaded into the RAM upon determining that the code data is not stored in the RAM. In certain embodiments, code data stored in the disk is loaded into the RAM upon determining that the code data is not stored in the nonvolatile memory.

In certain embodiments, the nonvolatile memory is a flash memory.

According to still another embodiment of the inventive concept, a method of loading data from memory system to a processor comprises determining whether executable software code is stored in a RAM in response to a request to start the software, upon determining that the code is not stored in the RAM, determining whether the code is stored in a nonvolatile memory, and upon determining that the code is not stored in the nonvolatile memory, loading the code data from a disk into the RAM.

In certain embodiments, the method further comprises upon determining that the code is stored in the RAM, executing the code in the processor.

In certain embodiments, the method further comprises upon determining that the code is stored in the nonvolatile memory, loading the code from the nonvolatile memory to the RAM. In certain embodiments, the code is operating system code.

In certain embodiments, the method further comprises executing a hibernation operation by transferring code from the RAM to the disk prior to disconnecting power from the RAM, and restoring the code from the disk to the RAM upon restoring power to the RAM.

### BRIEF DESCRIPTION OF THE DRAWINGS

Embodiments of the inventive concept are described below with reference to the accompanying drawings. In the drawings, like reference numbers indicate like features.

FIG. 1 is a diagram illustrating a memory system according to an embodiment of the inventive concept.

FIG. 2 is a diagram illustrating a life cycle of a page of data stored in a main memory of the memory system of FIG. 1.

FIG. 3 is a flowchart illustrating a method of loading a page of data in a memory system according to an embodiment of the inventive concept.

FIG. 4 is a flowchart illustrating a method of storing a page of data in a nonvolatile memory within a memory system according to an embodiment of the inventive concept.

FIG. 5 is a diagram illustrating hibernation of a memory system according to an embodiment of the inventive concept.

FIG. 6 is a diagram illustrating a memory system according to another embodiment of the inventive concept.

FIG. 7 is a diagram illustrating a memory system incorporating a solid state drive according to an embodiment of the inventive concept.

### DETAILED DESCRIPTION OF THE EMBODIMENTS

Selected embodiments of the inventive concept are described below with reference to the accompanying drawings. These embodiments are presented as teaching examples and should not be construed to limit the scope of the inventive concept.

In certain embodiments, a memory system comprises a nonvolatile memory device used as a swap space for a random access memory (RAM). By using the nonvolatile memory devices as a swap space, the memory system can efficiently load necessary data into the RAM when starting software. Consequently, the memory system can efficiently start the software.

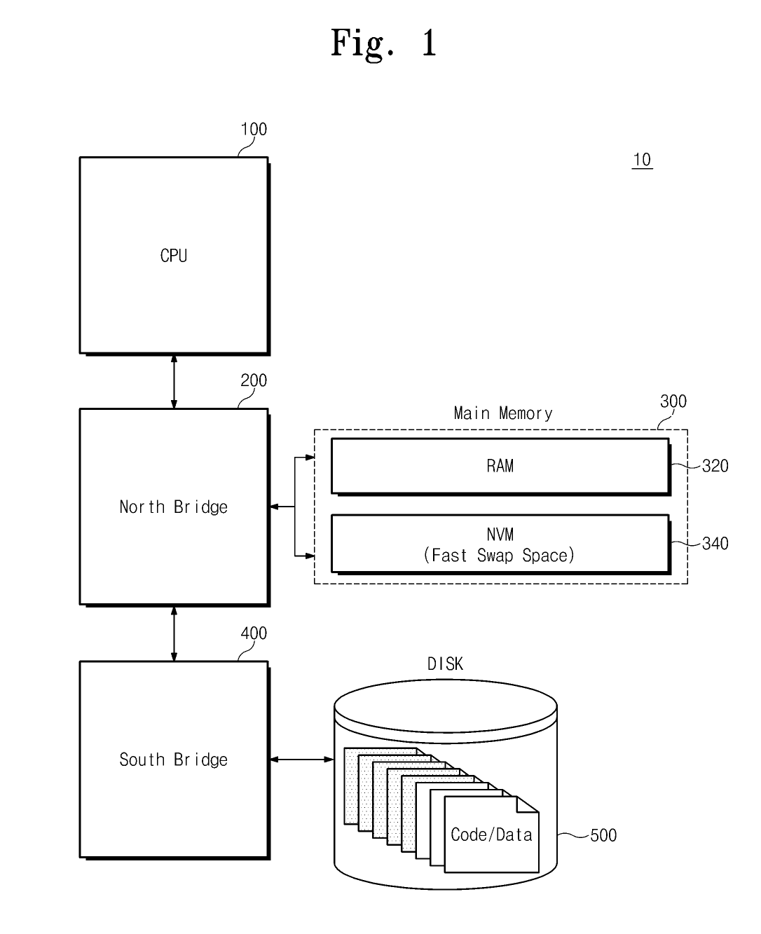

FIG. 1 is a diagram illustrating a memory system 10 according to an embodiment of the inventive concept.

Referring to FIG. 1, memory system 10 comprises a processor such as a central processing unit (CPU) 100, a north bridge 200, a main memory 300, a south bridge 400, and a disk 500.

CPU 100 controls the operation of memory system 10. Additionally, CPU 100 directly accesses main memory 300 via north bridge 200, and indirectly accesses disk 500 via south bridge 400.

North bridge 200 is connected to CPU 100 and typically comprises a hardware or software module for connecting elements or peripheral devices that require high transmission speed and high system performance.

Main memory 300 comprises a RAM 320 and a nonvolatile memory 340. During operation of memory system 10, RAM 320 stores data to be accessed by CPU 100. RAM 320 typically comprises a DRAM or an SRAM.

Because RAM 320 has a finite amount of storage space, memory system 10 uses additional storage space provided by nonvolatile memory 340 and disk 500 to implement virtual memory expansion for RAM 320. Memory system 10 implements virtual memory expansion for RAM 320 using nonvolatile memory 340 as a main memory swap space, and using a part of disk 500 as a disk swap space. During operation of memory system 10, data is transferred between RAM 320 and the various swap spaces. The data is typically transferred in pages.

The amount of time required to access the main memory swap space is less than the amount of time required to access the disk swap space. Accordingly, in this regard, nonvolatile memory 340 provides a faster swap space compared with disk 500.

Nonvolatile memory 340 can also be used to back up data used by RAM 320. Nonvolatile memory 340 can comprise any of several types of nonvolatile memory, such as NOR or NAND flash memory, phase change random access memory (PRAM), magnetoresistive random access memory (MRAM), or ferroelectric random access memory (FRAM), to name but a few. In main memory 300, RAM 320 and nonvolatile memory 340 can be implemented with a common interface, or they can be implemented with separate interfaces.

South bridge 400 is connected to north bridge 200 and typically comprises a hardware or software module for connecting system elements or peripheral devices that require high transmission speed and high system performance.

Disk 500 is connected to south bridge 400 and typically provides mass data storage for storing both user data and system data. Disk 500 typically stores boot code and data, as well as application code and data for an operating system. In other words, operating system and application programs of memory system 10 are stored in disk 500. In various alternative embodiments, disk 500 can comprise a flash memory device, a hard disk drive, or a solid state drive.

As indicated above, disk 500 comprises a disk swap space, which can be used to back up data used by RAM 320. In certain embodiments, the disk swap space can be omitted from disk 500. In general, CPU 100 can access data directly from the disk swap space or the main memory swap space.

Because memory system 10 comprises a swap space in nonvolatile memory 340 of main memory 300, the access speed of the swap space may be faster than in conventional systems. Among other things, this can be useful for loading software such operating systems and applications into RAM 320, and can eliminate the need to access disk 500 in certain circumstances. In general, the swap space provided by nonvolatile memory 340 may decrease the access latency of memory system 10.

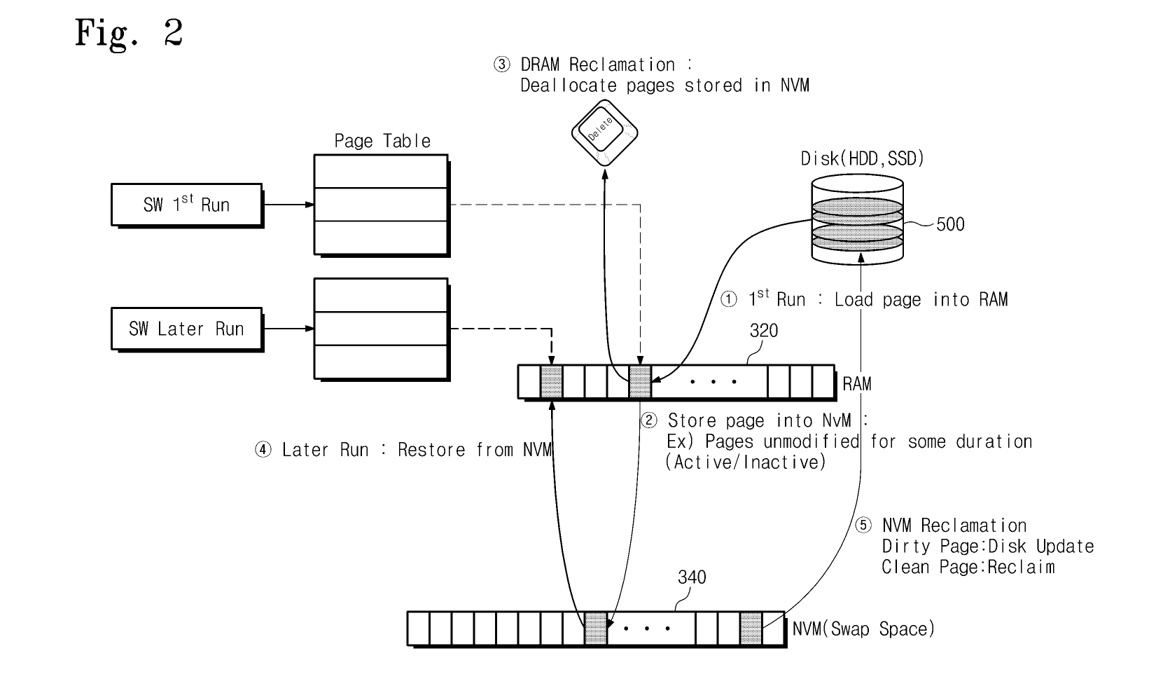

FIG. 2 is a diagram illustrating a life cycle of a page of data stored in a main memory of the memory system of FIG. 1. The life cycle is described below with reference to FIGS. 1 and 2. The description proceeds in an order corresponding to circled numbers 1-5 in FIG. 2, denoted by parentheses below.

In a first swap operation, a page of a page table is transferred from disk 500 to RAM 320 (1). In a reclamation operation of RAM 320, a page is transferred from RAM 320 to nonvolatile memory 340 before it is dumped by RAM 320 (2). In other words, the page stored in RAM 320 is backed up in nonvolatile memory 340. The term “reclamation” here denotes an operation performed by an operating system to “reclaim” memory in the main memory, typically based on usage. For example, a page in RAM 320 that has not been modified within a certain duration may be transferred to nonvolatile memory 340.

A page in RAM 320 can be deactivated where no read or write operation is performed on the page during a specified time interval. Similarly, the page can be activated upon performance of a read or write operation. The reclamation operation can then remove deactivated pages through a sweep of RAM 320.

The timing for deactivating pages in RAM 320 can be implemented in any of various forms. For instance, in one embodiment, deactivation occurs according to a time interval required to perform each of several repeated sweeps of RAM 320. In a sweep operation, pages that have updated contents or that are not already backed up in nonvolatile memory 340 are typically stored in nonvolatile memory 340.

Certain pages of data in RAM 320 can be selectively backed up in nonvolatile memory 340 based on the type of data stored therein. For instance, data in certain data structures, such as a heap or stack, can be retained in RAM 320 or backed up in nonvolatile memory 340 based on data access requirements. Similarly, executable code or data can be retained in RAM 320 or backed up in nonvolatile memory 340 based on code or data access requirements.

In the reclamation operation of RAM 320, pages stored in nonvolatile memory 340 are erased from RAM 320 (3). Accordingly, pages stored in nonvolatile memory 340 can be restored to RAM 320 upon execution of a further swap operation (4).

In a reclamation operation of nonvolatile memory 340, a clean page of data in nonvolatile memory 340 is backed up in disk 500, or a dirty page of data in nonvolatile memory 340 is stored in disk 500 (5). The term “dirty page” here refers to a page of nonvolatile memory 340 that differs from a corresponding page stored in disk 500, or for which a corresponding page does not exist in disk 500. A “clean page”, on the other hand, is a page in nonvolatile memory 340 that has a matching page in disk 500.

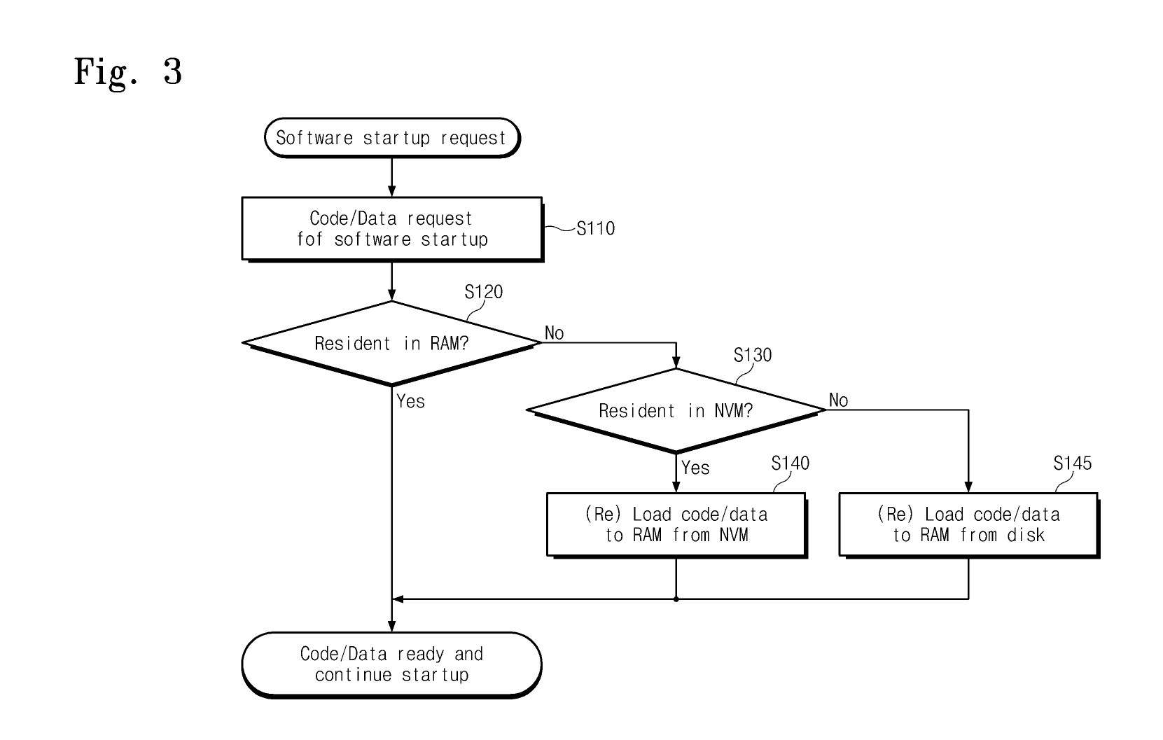

FIG. 3 is a flowchart illustrating a method of loading a page of data in a memory system according to an embodiment of the inventive concept. The method is described below with reference to FIGS. 1 through 3. In the description that follows, example method steps will be denoted by parentheses (SXXX).

The method begins upon receipt of a software startup request by memory system 10. In response to the request, CPU 100 requests a code/data necessary to perform software startup (S110). Thereafter, memory system 10 determines whether the requested code/data is stored in RAM 320 (S120).

Where the requested code/data is stored in RAM 320 (S120=Yes), the software startup operation is performed with the existing code/data. On the other hand, where the requested code/data is not stored in RAM 320 (S120=No), memory system 10 determines whether the requested code/data is stored in nonvolatile memory 340 (S130).

Where the requested code/data is stored in nonvolatile memory 340 (S130=Yes), the code/data stored in nonvolatile memory 340 is loaded into RAM 320 (S140), and then the start operation of the software is performed according to the code/data loaded into RAM 320. On the other hand, where the requested code/data does is not stored in nonvolatile memory 340 (S130=No), code/data stored in disk 500 is loaded into RAM 320 (S145), and then the start operation of the software is performed according to the code/data loaded into RAM 320.

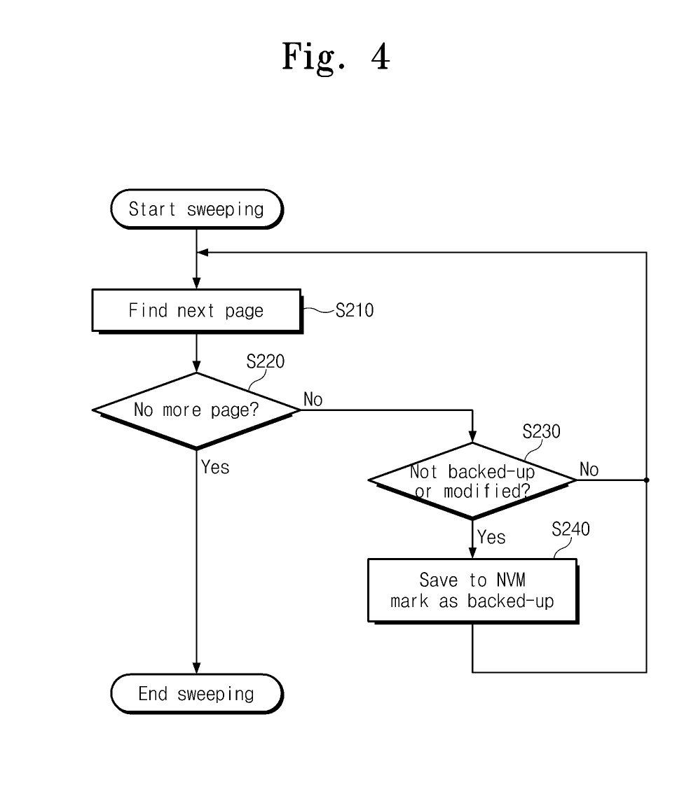

FIG. 4 is a flowchart illustrating a method for storing a page of data in a nonvolatile memory in a memory system according to an embodiment of the inventive concept. This method is described below with reference to FIGS. 1, 2, and 4.

It is assumed that memory system 10 periodically sweeps RAM 320 to reclaim memory pages. Memory system 10 begins by attempting to identify a page to examine (S210). Memory system 10 then determines whether any page was identified (S220). Upon determining that there are no further pages to examine (S220=Yes), the method terminates. Otherwise, where memory system 10 determines that there is at least one more page to examine (S220=No), memory system 10 proceeds to examine the page.

In examining the page, memory system 10 determines whether the page has been backed up in nonvolatile memory 340, or whether the page has been modified since the previous backup (S230). Where the page has not been backed up or it has been modified (S230=Yes), memory system 10 transfers a copy of the page in nonvolatile memory 340 and marks the page as backed up (S240). Otherwise, (S230=No), the method returns to step S210.

In the method of FIG. 4, pages of data can also be backed up in disk 500 during step S240. In addition, operations for sweeping nonvolatile memory 340 can be performed similar to the operations described for sweeping RAM 320.

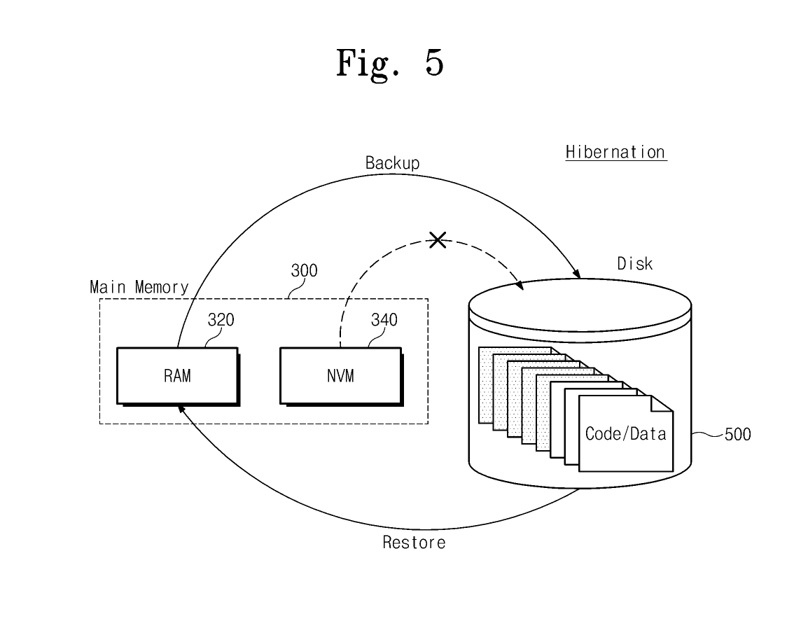

FIG. 5 is a diagram illustrating a hibernation operation of memory system 10 according to an embodiment of the inventive concept. The hibernation operation is used to manage power consumption of memory system 10. In the hibernation operation, data in RAM 320 is stored in disk 500 so that it is not lost when power is disconnected from memory system 10. The hibernation operation is designed to allow efficient restarting of memory system 10 after power down. It is also designed to allow programs, such as applications, to be stored in a current state without requiring them to be shut down.

Memory system 10 uses data stored in main memory 300 while performing operations. In other words, memory system 10 uses main memory 300 as a working memory and stores working data in RAM 320 and nonvolatile memory 340. In the hibernation operation, memory system 10 backs up data from RAM 320 to disk 500, but may not back up data stored in nonvolatile memory 340. To restore the data subsequent to the hibernation operation, memory system 10 loads the backed up data from disk 500 to RAM 320. Accordingly, in memory system 10, the amount of backup data and the amount of restored data may be reduced by comparison with other systems. Accordingly, memory system 10 can provide a shortened hibernation on/off time.

Where memory system 10 is incorporated in a portable computer, the booting time of an operating system and the on/off time of hibernation can be shortened, thereby decreasing power consumption. Accordingly, the use time of a battery that can be used through one-time charge can be increased.

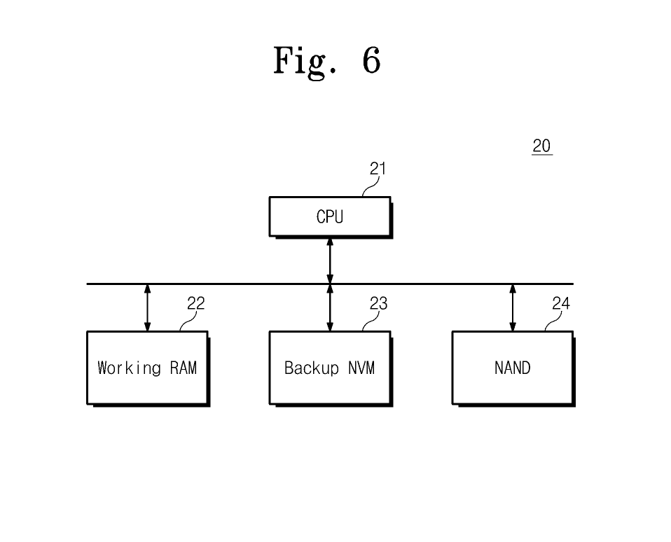

FIG. 6 is a diagram illustrating a memory system 20 according to another embodiment of the inventive concept.

Referring to FIG. 6, memory system 20 comprises a CPU 21, a working RAM 22, a backup nonvolatile memory 23, and a NAND flash memory 24.

CPU 21 controls the overall operation of memory system 20, and working RAM 22 temporarily stores data used by CPU 21. Working RAM 22 typically comprises a nonvolatile memory such as a DRAM, a SRAM or an M-SDRAM.

Backup nonvolatile memory 23 is used to back up pages of working RAM 22. Page backup operations of working RAM 22 are performed similar to page backup operations described above with reference to FIGS. 1 through 5. Backup nonvolatile memory 23 typically stores boot code and data for memory system 20 and a host system, as well as metadata of NAND flash memory 24. NAND flash memory 24 is typically controlled with the stored metadata. Backup nonvolatile memory 23 is used as a fast swap space of working RAM 22.

NAND flash memory 24 at least one NAND flash memory, and can be used, for instance, to store user data.

In some embodiments, memory system 20 can be used to provide storage for a mobile device. For instance, memory system 20 can be used as storage for an MP3 player, digital camera, PDA, or e-book, to name but a few. The memory system can also be used in other types of devices such as digital televisions or computers. Additionally, the memory system can be used in a SSD.

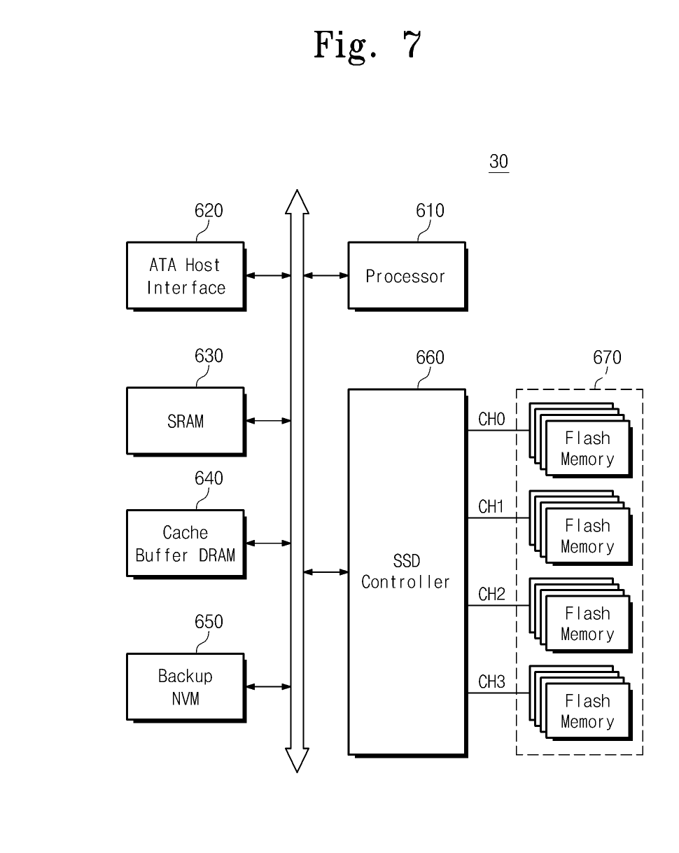

FIG. 7 is a diagram illustrating a SSD memory system 30 according to an embodiment of the inventive concept.

Referring to FIG. 7, SSD memory system 30 comprises a processor 610, an ATA host interface 620, an SRAM 630, a cache buffer DRAM 640, a backup nonvolatile memory 650, an SSD controller 660, and a plurality of flash memories 670.

Processor 610 receives commands from a host and controls operations for reading and storing data in flash memories 670 based on the commands.

ATA host interface 620 exchanges data with the host under the control of processor 610. ATA host interface 620 fetches commands and addresses from the host and transfers the fetched commands and addresses to processor 610 via a CPU bus. ATA host interface 620 typically comprises one of an SATA interface, a PATA interface and an external SATA (ESATA) interface.

Data received from the host by ATA host interface 620 and data to be transmitted to the host may, in some embodiments, be transferred to or from cache buffer RAM 640 without passing though the CPU bus.

RAM 630 is used to temporarily store data used to operation SSD memory system 30. RAM 630 typically comprises a volatile memory such as a DRAM or an SRAM.

Cache buffer RAM 640 temporarily stores data transferred between the host and flash memories 670. Cache buffer RAM 640 may also be used to store programs to be operated by processor 610. Cache buffer RAM 640 typically comprises an SRAM.

Backup nonvolatile memory 650 is used as the swap space of cache buffer RAM 640. Backup nonvolatile memory 650 stores unused pages identified in periodic sweeping operations of cache buffer RAM 640.

SSD controller 660 exchanges data with flash memories 670. In various embodiments, SSD controller 660 can be designed to support different types of memory, such as a NAND flash memory, a One-NAND flash memory, a multi-level cell flash memory, or a single level cell flash memory.

Certain memory systems and/or storage devices according to embodiments of the inventive concept may be mounted with various types of packages. For example, the memory system and/or the storage device according to embodiments of the inventive concept may be mounted with packages such as package on package (PoP), ball grid arrays (BGAs), chip scale packages (CSPs), plastic leaded chip carrier (PLCC), plastic dual in-line package (PDIP), die in waffle pack (DIWP), die in wafer form (DIWF), chip on board (COB), ceramic dual in-line package (CERDIP), plastic metric quad flat pack (MQFP), thin quad flat pack (TQFP), small outline package (SOP), shrink small outline package (SSOP), thin small outline package (TSOP), system in package (SIP), multi chip package (MCP), wafer level stack package (WLSP), die in wafer form (DIWF), die on waffle package (DOWP), wafer-level fabricated package (WFP) and wafer-level processed stack package (WSP).

As described above, memory systems according to certain embodiments of the inventive concept use a nonvolatile memory as a swap space for a RAM. These memory systems can improve the efficiency of swap operations compared with conventional memory systems.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A method of operating a memory system comprising a processor, a main memory comprising a volatile random access memory (RAM) and a nonvolatile memory, and a disk, the method comprising:
maintaining separate copies of a page of data in the RAM, the nonvolatile memory, and the disk;
transferring the page of data from the nonvolatile memory to the RAM with a first latency;
transferring the page of data from the disk to the RAM with a second latency greater than the first latency.

2. The method of claim 1, further comprising:
transferring an updated copy of the page of data from the RAM to the nonvolatile memory upon detecting a change in the page of data stored in the RAM.

3. The method of claim 1, further comprising:
removing the copy of the page of data from the RAM upon determining that the copy of the page stored in the RAM has not been accessed by the processor during a predetermined time interval.

4. The method of claim 1, further comprising:
removing the copy of the page of data from the nonvolatile upon determining that the copy of the page stored in the nonvolatile memory has not been accessed during a predetermined time interval.

5. The method of claim 1, further comprising:
transferring an updated copy of the page of data from the nonvolatile memory to the disk upon detecting a change in the page of data stored in the nonvolatile memory.

6. A memory system, comprising:
a processor;
a main memory comprising a volatile random access memory (RAM) that stores data to be accessed by the processor, and a nonvolatile memory that provides a swap space for the RAM; and
a disk that provides data transfer to the RAM with a greater latency than the nonvolatile memory.

7. The memory system of claim 6, wherein the disk provides an additional swap space for the RAM.

8. The memory system of claim 6, wherein a page that is not accessed by the processor during a predetermined time interval is stored in the nonvolatile memory during a reclamation operation of the RAM.

9. The memory system of claim 6, wherein a boot code or data of the memory system is loaded into the RAM during initialization.

10. The memory system of claim 6, wherein a dirty page stored in the nonvolatile memory is updated in the disk.

11. The memory system of claim 6, further comprising:
a north bridge connected between the processor and the main memory to transfer data between the processor and the main memory; and
a south bridge connected between the north bridge and the disk to transfer data between the processor and the disk.

12. The memory system of claim 11, wherein the nonvolatile memory is a phase-change random access memory.

13. The memory system of claim 11, wherein code data stored in the nonvolatile memory is loaded into the RAM upon determining that the code data is not stored in the RAM.

14. The memory system of claim 11, wherein code data stored in the disk is loaded into the RAM upon determining that the code data is not stored in the nonvolatile memory.

15. The method of claim 1, wherein the nonvolatile memory is a flash memory.

16. A method of loading data from memory system to a processor, comprising:
determining whether executable software code is stored in a volatile random access memory (RAM) in response to a request to start the software;
upon determining that the code is not stored in the RAM, determining whether the code is stored in a nonvolatile memory; and
upon determining that the code is not stored in the nonvolatile memory, loading the code from a disk into the RAM.

17. The method of claim 16, further comprising:
upon determining that the code is stored in the RAM, executing the code in the processor.

18. The method of claim 16, further comprising:
upon determining that the code is stored in the nonvolatile memory, loading the code from the nonvolatile memory to the RAM.

19. The method of claim 16, wherein the code is operating system code.

20. The method of claim 16, further comprising:
executing a hibernation operation by transferring code from the RAM to the disk prior to disconnecting power from the RAM; and
restoring the code from the disk to the RAM upon restoring power to the RAM.
